(19) United States
(12) Patent Application Publication
(10) Pub. No.: US 2025/0145058 A1
(43) Pub. Date: May 8, 2025

(54) LOUNGE MODE FOR A VEHICLE PASSENGER SEAT

(71) Applicant: Fisker Inc., Manhattan Beach, CA (US)

(72) Inventors: Paul Famiglietti, Manhattan Beach, CA (US); Tony Kmeid, Manhattan Beach, CA (US)

(21) Appl. No.: 18/504,580

(22) Filed: Nov. 8, 2023

(51) Int. Cl. B60N 2/02

(52) U.S. Cl. CPC B60N 2/0292; B60N 2/0244; B60N 2/0272

(57) ABSTRACT

The technology disclosed herein enables repositioning of a seat cushion to put a vehicle passenger seat in a lounge mode. In a particular example, an apparatus includes the seat cushion, a forward support affixed at a first end to an underside of the seat cushion, and a first pivot connecting a second end of the forward support to a vehicle floor. The forward support and the seat cushion rotate around the pivot between a driving position and a lounge position. The apparatus further includes a rearward support that, when in a deployed position, supports a rearward end of the seat cushion from where the forward support is affixed in the lounge position. The rearward support is in a stowed position when the seat cushion is in the driving position. The apparatus also includes a second pivot around which the rearward support rotates between the deployed position and the stowed position.

### BACKGROUND

There are often situations when a person may want to lie down in their car. For instance, a person may be waiting for something and decide to catch up on some sleep. Even with the large number of adjustment points in modern vehicle passenger seats, it can be difficult to comfortably lie down in a vehicle passenger seat. The backrest may not recline far enough or, when the backrest does recline, the seat cushion and the backrest may not align so as to provide a passenger with a straight surface on which to lay. Thus, the passenger's ability to make the most of their resting time may be compromised by poor comfort when trying to lie down.

### SUMMARY

The technology disclosed herein enables repositioning of a seat cushion for a vehicle passenger seat relative to a backrest so the vehicle passenger seat can enter a lounge mode. In a particular example, an apparatus includes the seat cushion, a forward support affixed at a first end to an underside of the seat cushion, and a first pivot connecting a second end of the forward support to a vehicle floor. The forward support and the seat cushion rotate around the pivot between a driving position and a lounge position. The apparatus further includes a rearward support that, when in a deployed position, supports a rearward end of the seat cushion from where the forward support is affixed in the lounge position. The rearward support is in a stowed position when the seat cushion is in the driving position. The apparatus also includes a second pivot around which the rearward support rotates between the deployed position and the stowed position.

In another example, a method includes receiving a signal from a sensor indicating whether the seat cushion is in the driving position and preventing the vehicle from entering a drive mode when the signal indicates the seat cushion is in the lounge position. The seat cushion is in the lounge position when a rearward support is in a deployed position where the rearward support supports a reward end of the seat cushion from where a forward support supports the seat cushion. The rearward support is in a stowed position when the seat cushion is in the driving position.

In another example, an apparatus performs the above-recited method with computer readable storage media directing a processing system to perform the above-recited method.

### BRIEF DESCRIPTION OF THE DRAWINGS

FIG. 1 illustrates rear seating for a vehicle that can be configured into a lounge mode.

FIG. 2 illustrates rear seating for a vehicle with a passenger seat configured into a lounge mode.

FIG. 3 illustrates an underside of a passenger seat of a vehicle that can be configured into a lounge mode.

FIG. 4 illustrates a side profile of a passenger seat of a vehicle that can be configured into a lounge mode.

FIG. 5 illustrates a side profile of a passenger seat of a vehicle that can be configured into a lounge mode.

FIG. 6 illustrates a side profile of a passenger seat of a vehicle that can be configured into a lounge mode.

FIG. 7 illustrates a side profile of a passenger seat of a vehicle that can be configured into a lounge mode.

FIG. 8 illustrates a side profile of a passenger seat of a vehicle configured into a lounge mode.

FIG. 9 illustrates a computing system for determining whether a passenger seat of a vehicle is in a lounge mode.

### DETAILED DESCRIPTION

The vehicle passenger seat in the examples below can be transitioned between two different modes. One mode enables a passenger to sit upright, as one normally would in a vehicle. The other position allows the passenger to comfortably lie down in the vehicle, preferably while the vehicle is not in motion for safety. The upright mode is referred to herein as the passenger seat's driving mode while the laying down position is referred to as the passenger seat's lounge mode. With the seat in its lounge mode, a passenger can lie down to relax, sleep, or otherwise spend their time in a position that may be more comfortable than sitting upright. While a vehicle passenger seat may have the ability to change the incline of the seat's backrest (e.g., to make the upright driving position more comfortable), reclining the seat all the way may not result in a surface straight enough to consider laying down on comfortably. Rather, an offset may exist between the surface provided by a seat cushion of the passenger seat and a surface provided by the reclined backrest. Laying on such offset surfaces may be uncomfortable.

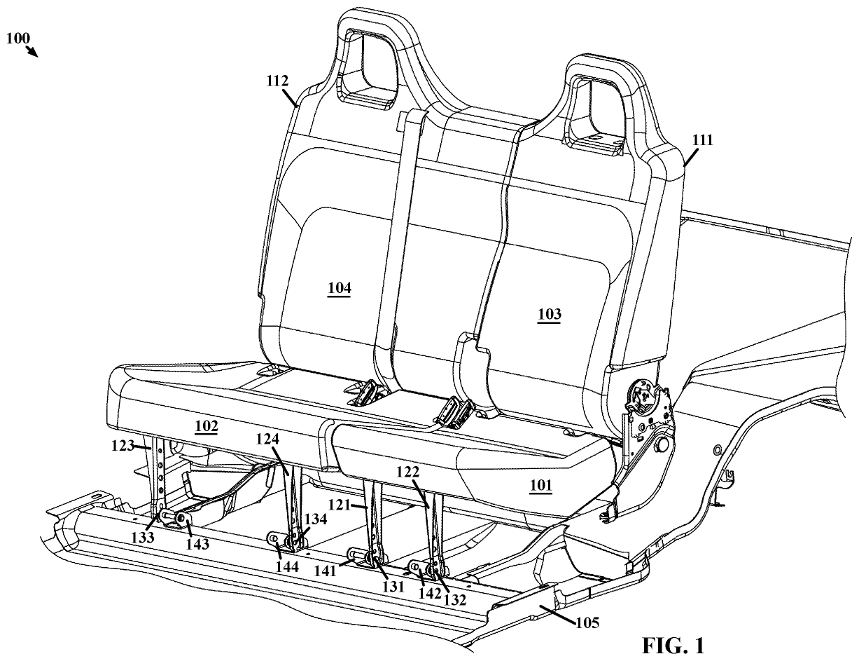

FIG. 1 illustrates rear seating 100 for a vehicle that can be configured into a lounge mode. Rear seating 100 is an example of a seating behind a driver seat for a vehicle. Rear seating 100 may be located immediately behind the driver seat or may be multiple rows back for larger vehicles, such as sport utility vehicles (SUVs) or vans. Rear seating 100 includes passenger seat 111 and passenger seat 112. The widths of passenger seat 111 and passenger seat 112 create what is commonly referred to as a 60/40 split bench for rear seating 100 with passenger seat 112 being wide enough to accommodate a second passenger while passenger seat 111 is only wide enough for one. The widths of passenger seat 111 and passenger seat 112 may comprise different portions of rear seating 100 in other examples. Similarly, rear seating 100 may be split into more than two sections of passenger seats or may be one continuous bench all the way across. In some examples, rear seating 100 may not include a bench form factor. Rather, each seat may be for individual passengers (e.g., the vehicle may include two rear bucket seats rather than a bench). While described predominantly as being an automotive rear seat, rear seating 100 may be seating included in other types of vehicles, such as boats, planes, and trains. Likewise, while being defined as rear seating, the seats may be located in other areas of the vehicle. For instance, a front seat may be configured to enter a lounge mode as described herein.

In this example, passenger seat 111 includes seat cushion 101 and backrest 103. Passenger seat 112 includes seat cushion 102 and backrest 104. Seat cushion 101 and backrest 103 are not necessarily attached to one another even though they together form a passenger seat. Seat cushion 101 and seat cushion 102 are referred to as seat cushions but merely refer to the areas on passenger seat 111 and passenger seat 112 upon which passengers sit. In some examples, seat cushion 101 and seat cushion 102 may contain little to no actual cushioning material. Backrest 103 and backrest 104 are typically made of similar materials to seat cushion 101 and seat cushion 102 to form a cohesive passenger seat 111 and passenger seat 112.

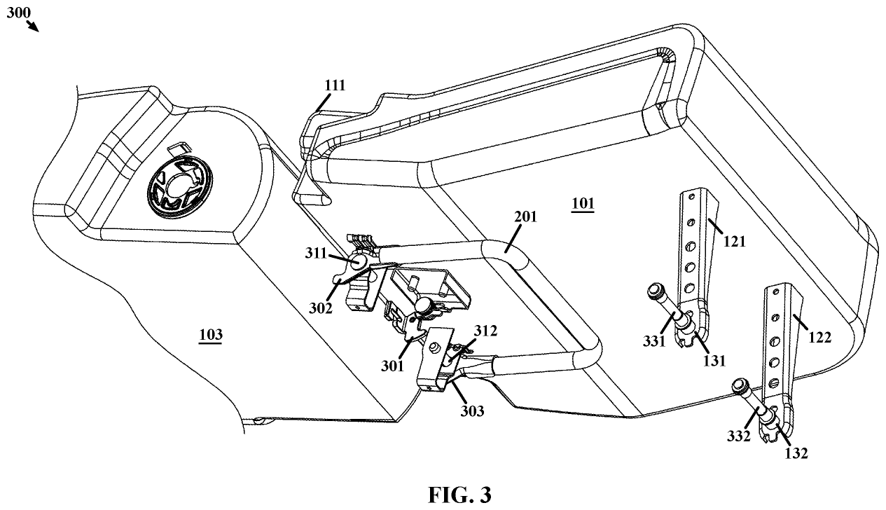

Forward support 121 and forward support 122 are statically affixed (e.g., bolted, riveted, welded, or otherwise) at one end to the underside of seat cushion 101 towards the front of seat cushion 101. In some examples, forward support 121 and forward support 122 may be considered part of a seat frame for seat cushion 101. The front of seat cushion 101 is relative to a direction in which a passenger would be seated in passenger seat 111. Since passenger seat 111 may be mounted facing backwards in a vehicle, the front of seat cushion 101 is not necessarily towards the front of the vehicle. At the opposite end of forward support 121 and forward support 122 are pivot 131 and pivot 132, respectively. Pivot 131 and pivot 132 are created by connecting forward support 121 and forward support 122 to bracket 141 and bracket 142 using pin 331 and pin 332, which can be seen in FIG. 3. Bracket 141 and bracket 142 are statically affixed to vehicle floor 105. While two forward supports are used in this example, other examples may include any number of supports and the supports may be shaped differently as long as while still being strong enough to hold seat cushion 101 in position.

Like passenger seat 111, passenger seat 112 includes forward support 123 and forward support 124, which are statically affixed at one end to the underside of seat cushion 102 towards the front of seat cushion 102. At the opposite ends of forward support 123 and forward support 124 are pivot 133 and pivot 134, respectively, which connect forward support 123 and forward support 124 to bracket 143 and bracket 144. Bracket 143 and bracket 144 are statically affixed to vehicle floor 105 like bracket 141 and bracket 142. As with passenger seat 112 alternative forward support arrangements may also be used. Passenger seat 112 may, therefore, be able to switch between a driving mode and a lounge mode using the same mechanism as passenger seat 111, which is detailed below.

Rear seating 100 shows passenger seat 111 in driving mode with seat cushion 101 in the driving position and backrest 103 in an upright position. Driving mode is the preferred mode while the vehicle is in motion, as the seatbelts, airbags, and/or other safety features of the vehicle are typically designed to protect passengers in an upright seated position.

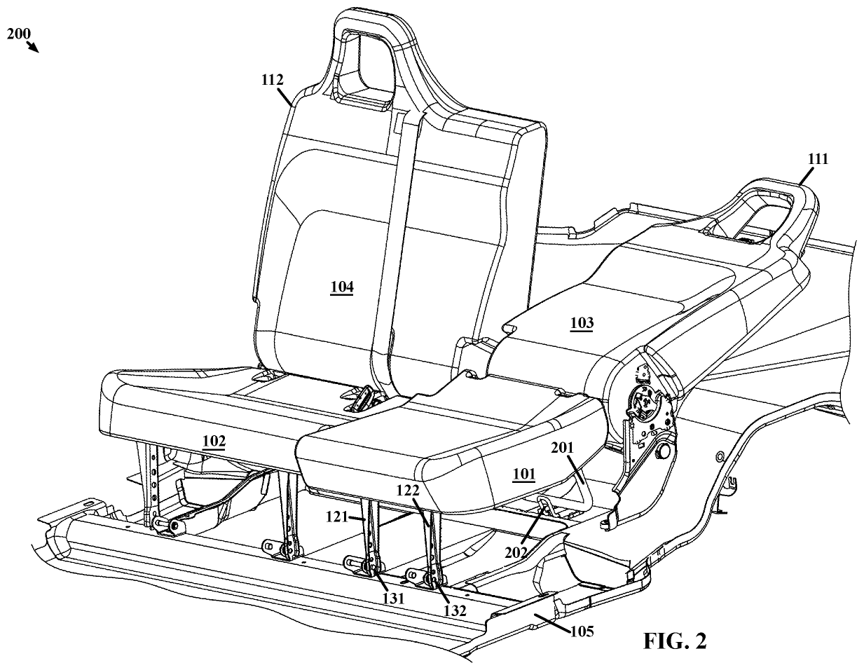

FIG. 2 illustrates rear seating 200 for a vehicle with passenger seat 111 configured into a lounge mode. Specifically, rear seating 200 is an example of rear seating 100 after repositioning passenger seat 111 from driving mode to lounge mode. In comparison to rear seating 100, rear seating 200 includes seat cushion 101 being higher at the rear than in rear seating 100, which is indicative of seat cushion 101 being in a lounge position for the lounge mode of passenger seat 111. Seat cushion 102 remains in the driving position. For seat cushion 101 to achieve the lounge position, seat cushion 101 was rotated around pivot 131 and pivot 132. For example, a user may pull up on the back of seat cushion 101 to rotate seat cushion 101. In some cases, a latch may be located at the back of seat cushion 101 to hold seat cushion 101 in the driving position until the user releases the latch (e.g., by pulling a latch release).

In the lounge mode shown for rear seating 200, rear support 201 is in a deployed position supporting the rear end of seat cushion 101 to prevent seat cushion 101 from rotating back into the driving position. In rear seating 100, rear support 201 was rotated up against the bottom of seat cushion 101 in a stowed position, as shown in later figures. This example further includes catch 202, which is affixed to vehicle floor 105 to prevent rear support 201 from rotating back to the stowed position while passenger seat 111 is in lounge mode. Catch 202 may be statically affixed to vehicle floor 105 or may be on a pivot allowing catch 202 to rotate up from vehicle floor 105 when needed.

FIG. 3 illustrates underside 300 of passenger seat 111 of a vehicle that can be configured into a lounge mode. Underside 300 shows rear support 201 when in a stowed position up against seat cushion 101. Rear support 201 is affixed to seat cushion 101 by pivot 311 and pivot 312, which allow rear support 201 to rotate between the stowed and deployed positions. Rear support 201 is a u-shaped single piece in this example but may be multiple supports in other examples. For instance, rear support 201 may instead be two pivoting supports like forward support 122 and forward support 121. Stopper 302 and stopper 303 are formed at the ends of rear support 201 to contact seat cushion 101 and prevent rear support 201 from over rotating beyond where rear support 201 should rotate in the deployed position. Underside 300 further shows pin 331 and pin 332, which spin within bracket 141 and bracket 142 to enable rotation of seat cushion 101 between the driving position and the lounge position. Other mechanisms enabling forward support 121 and forward support 122 to rotate on pivot 131 and pivot 132 may be used instead.

Underside 300 also shows latch 301 affixed to seat cushion 101. Latch 301 does not latch to anything when seat cushion 101 is in the lounge position but latches to latch anchor 401, shown in subsequent figures, when in the driving position. Latch 301 prevents seat cushion 101 from moving forward and rotating around pivot 131 and pivot 132 when seat cushion 101 is in the driving position. Rear support 201 may be held in the stowed position using indent(s), latch(es), strap(s), or some other holding mechanism.

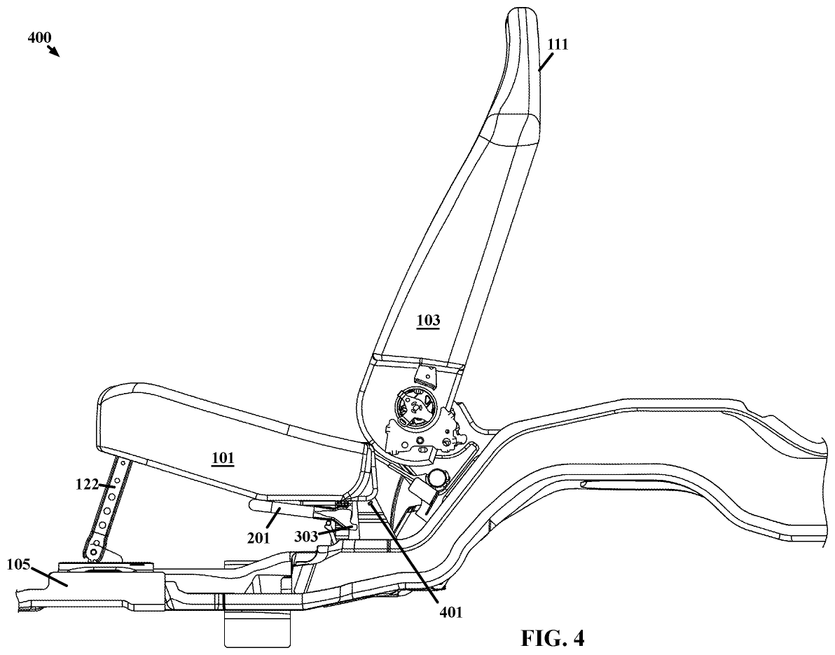

FIG. 4 illustrates side profile 400 of passenger seat 111 of a vehicle that can be configured into a lounge mode. Side profile 400 shows passenger seat 111 in driving mode like in rear seating 100. From side profile 400 rear support 201 can be seen positioned against the underside of seat cushion 101 in the stowed position. Side profile 400 further shows latch anchor 401 statically affixed to and protruding from vehicle floor 105. Latch 301 latches onto latch anchor 401 to prevent seat cushion 101 from rotating from the driving position. Latch anchor 401 further acts as a rear support for seat cushion 101 when seat cushion 101 is in the driving position with rear support 201 stowed. In other examples, one or more rear supports separate from latch anchor 401 and statically affixed to vehicle floor 105 may support the rearward portion of seat cushion 101 when in the driving position.

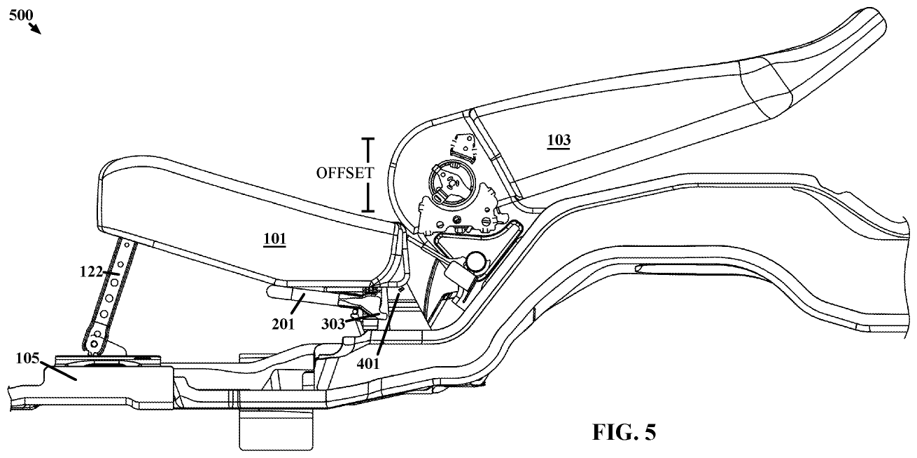

FIG. 5 illustrates side profile 500 of passenger seat 111 of a vehicle that can be configured into a lounge mode. Side profile 500 is an example of side profile 400 with backrest 103 reclined in preparation for seat cushion 101 to be changed from the driving position to the lounge position. Depending on the shapes of backrest 103 and seat cushion 101 and the positioning of seat cushion 101 and backrest 103 relative to each other, backrest 103 may not need to be reclined prior to changing the position of seat cushion 101. Rather, enough space may exist for seat cushion 101 to rotate even if backrest 103 is upright. Pivot 131 and pivot 132 being located on the floor end of forward support 121 and forward support 122 enable movement of seat cushion 101 forward from backrest 103 in addition to upwards during the rotation.

Side profile 500 also highlights an advantage of seat cushion 101's ability to be moved into a lounge position. In the driving position shown, there is an offset between the surface of seat cushion 101 and backrest 103. That offset may be uncomfortable for a passenger wanting to lie down, or lounge, in passenger seat 111. Moving seat cushion 101 into the lounge position, as detailed below, removes or substantially negates the offset.

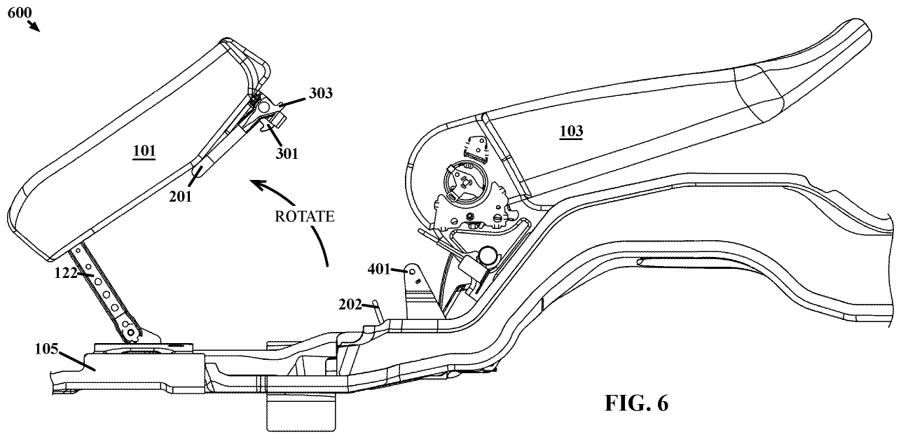

FIG. 6 illustrates side profile 600 of passenger seat 111 of a vehicle that can be configured into a lounge mode. Side profile 600 is an example of side profile 500 with seat cushion 101 rotated out of the driving position. Prior a user rotating seat cushion 101, the user released latch 301 via a latch release connected to latch 301 (e.g., a strap with one end connected to latch 301 and another end extending through a gap between seat cushion 101 and backrest 103).

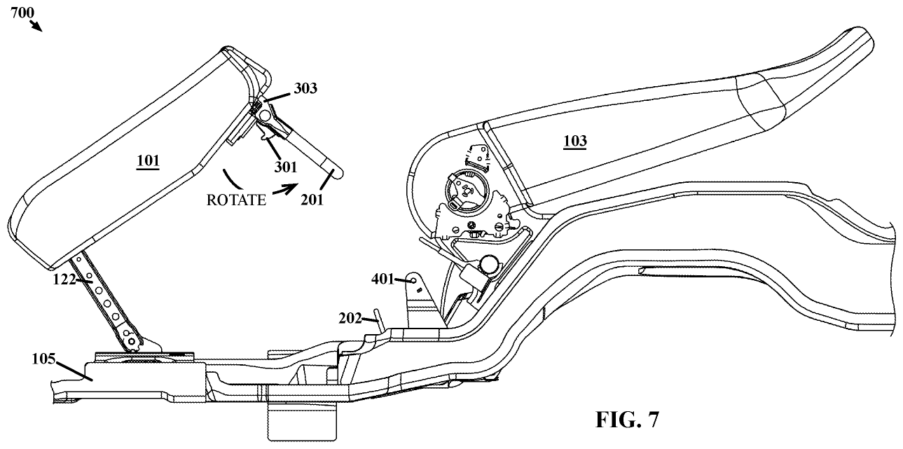

FIG. 7 illustrates side profile 700 of passenger seat 111 of a vehicle that can be configured into a lounge mode. Side profile 700 is an example of side profile 600 with rear support 201 rotated out from the stowed position to the deployed position. In this example, rear support 201 is rotated until stopper 302 and stopper 303 contact the underside of seat cushion 101. A holding mechanism, such as indents or a latch, may hold rear support 201 in the deployed position. In this example, rear support 201 is held in the deployed position by weight from seat cushion 101 and rear support 201's angle relative to vehicle floor 105. In some examples, vehicle floor 105 may include a groove into which rear support 201 fits when seat cushion 101 is rotated back down into the lounge position. Seat cushion 101 is rotated above a point necessary for rear support 201 to be deployed. Seat cushion 101 need only be rotated far enough to provide rear support 201 with clearance to rotate without contacting support catch 202. Although, in some examples, the space under seat cushion 101 may be available for storage. In those examples, rear support 201 would need to clear the storage.

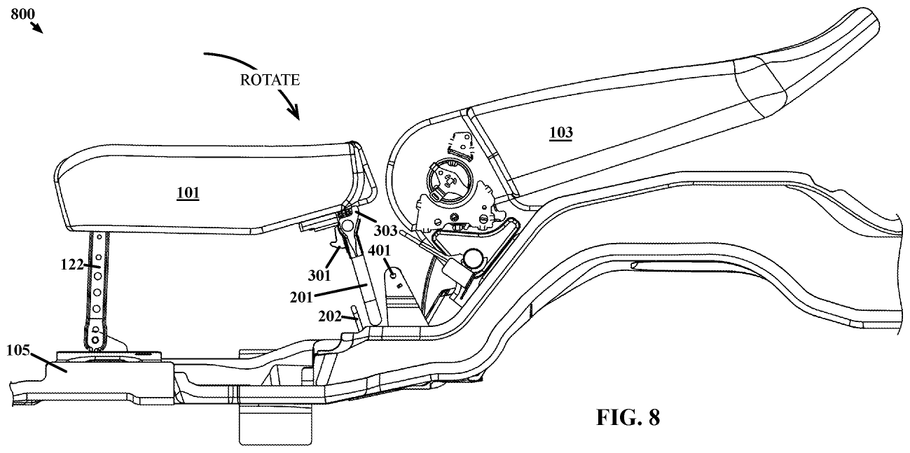

FIG. 8 illustrates side profile 800 of passenger seat 111 of a vehicle configured into a lounge mode. Side profile 800 is an example of side profile 700 with seat cushion 101 rotated back down until rear support 201 contacts vehicle floor 105. Once seat cushion 101 is down in the lounge position, passenger seat 111 is in lounge mode. When in the lounge position seat cushion 101 is rotated further counterclockwise from the perspective of side profile 800 than seat cushion 101 is when in the driving position. Rear support 201 is supporting the rear of seat cushion 101 to prevent seat cushion 101 from rotating further towards vehicle floor 105. The offset shown by side profile 500 has been minimized, if not removed entirely, which enables a passenger to lie down more comfortably on a substantially inline surface provided by seat cushion 101 and backrest 103.

The steps shown in FIGS. 4-8 to convert passenger seat 111 from driving mode to lounge mode may be reversed to convert passenger seat 111 back to driving mode from lounge mode. That is, seat cushion 101 is rotated up out of the lounge position far enough so that rear support 201 can be rotated back into the stowed position. Seat cushion 101 can then be rotated back down until latch 301 latches onto latch anchor 401 to complete seat cushion 101's conversion back into the driving position. Backrest 103 may then be returned to an upright position for passenger seat 111 to be returned to driving mode.

In the examples above, rear support 201 deploys from a stowed position under seat cushion 101. In other examples, rear support 201 may stow along vehicle floor 105 and rotate upwards from vehicle floor 105 (e.g., pivot 311 and pivot 312 may be located in brackets affixed to vehicle floor 105). To convert from the driving position to the lounge position, seat cushion 101 would still rotate out of the driving position but rear support 201 would rotate up from vehicle floor 105 rather than down from seat cushion 101. When seat cushion 101 is rotated back towards rear support 201, rear support 201 contacts seat cushion 101 to support the rear of seat cushion 101 from falling back into the driving position.

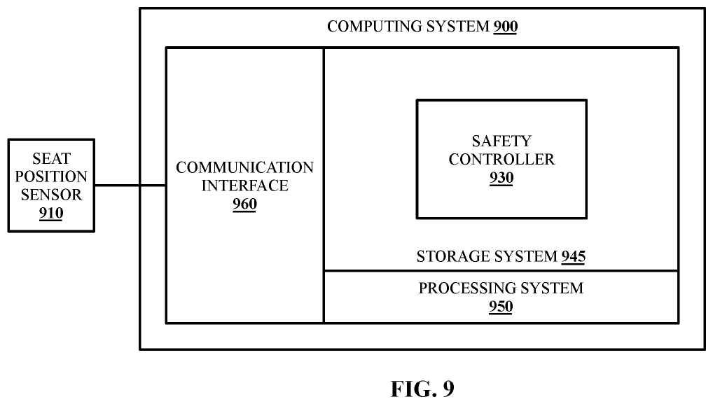

FIG. 9 illustrates computing system 900 for determining whether a passenger seat of a vehicle is in a lounge mode. Computing system 900 is an example architecture for a vehicle compute node configured to control one or more vehicle functions for a vehicle in which passenger seat 111 may be installed. Computing system 900 includes storage system 945, processing system 950, and communication interface 960. Processing system 950 is operatively linked to communication interface 960 and storage system 945. Communication interface 960 may be communicatively linked to storage system 945 in some implementations. Computing system 900 may further include other components such as a battery and enclosure that are not shown for clarity.

Communication interface 960 comprises components that communicate over communication links, such as network cards, ports, radio frequency (RF), processing circuitry and software, or some other communication devices. Communication interface 960 may be configured to communicate over metallic, wireless, or optical links. Communication interface 960 may be configured to use Time Division Multiplex (TDM), Internet Protocol (IP), Ethernet, optical networking, wireless protocols, communication signaling, or some other communication format—including combinations thereof. Communication interface 960 is configured to receive a signal from seat position sensor 910.

Processing system 950 comprises microprocessor and other circuitry that retrieves and executes operating software from storage system 945. Storage system 945 may include volatile and nonvolatile, removable, and non-removable media implemented in any method or technology for storage of information, such as computer readable instructions, data structures, program modules, or other data. Storage system 945 may be implemented as a single storage device but may also be implemented across multiple storage devices or sub-systems. Storage system 945 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no examples would storage media of storage system 945, or any other computer-readable storage medium herein, be considered a transitory form of signal transmission (often referred to as “signals per se”), such as a propagating electrical or electromagnetic signal or carrier wave.

Processing system 950 is typically mounted on a circuit board that may also hold the storage system. The operating software of storage system 945 comprises computer programs, firmware, or some other form of machine-readable program instructions. The operating software of storage system 945 comprises safety controller 930. The operating software on storage system 945 may further include an operating system, utilities, drivers, network interfaces, applications, or some other type of software. When read and executed by processing system 950 the operating software on storage system 945 directs computing system 900 to prevent the vehicle in which computing system 900 and passenger seat 111 are installed from driving when passenger seat 111 is in lounge mode. Safety controller 930 may execute natively on processing system 950 or the operating software may include virtualization software, such as a hypervisor, to virtualize computing hardware on which safety controller 930 executes.

In an example, seat position sensor 910 sends a signal to communication interface 960 indicating whether seat cushion 101 is in the driving position. Seat position sensor 910 may be a pressure sensor indicating that rear support 201 is in contact with vehicle floor 105, may be a sensor on seat cushion 101 indicating whether rear support 201 is in the stowed position, may be a sensor on latch 301 indicating whether latch 301 is latched to latch anchor 401, or may be any other type of sensor that may indicate seat cushion 101 is in the driving position. Similarly, seat position sensor 910 may indicate that seat cushion 101 is in the lounge position to indicate that seat cushion 101 is not in the driving position. In some examples, multiple sensors may be used to determine whether seat cushion 101 is in the driving position. All or a threshold number of the sensors may indicate that seat cushion 101 is in the driving position for safety controller 930 to conclude seat cushion 101 is in the driving position. When the signal from seat position sensor 910 (or signals from multiple sensors) indicate that seat cushion 101 is not in the driving position, safety controller 930 prevents the vehicle from entering a drive mode (e.g., from entering a forward or reverse gear/motor direction). Safety controller 930 may, therefore, force the vehicle to remain in park, or otherwise not in a drive mode, until seat cushion 101 is moved into the driving position, as indicated by the signal from seat position sensor 910.

If more seats in the vehicle can also enter a lounge mode (e.g., passenger seat 112), additional seat position sensors from those seats will also indicate that the seat cushions from those seats are in the driving position. Safety controller 930 may require all seat cushions be in the driving position before allowing the vehicle to enter a drive mode. In some examples, one or more additional sensors may be used to indicate to safety controller 930 whether backrest 103 (or backrests of other seats in the vehicle) are also upright prior to allowing the vehicle to enter a drive mode. If computing system 900 also controls the drive modes of the vehicle, safety controller 930 itself may not allow user input directing the vehicle to enter a drive mode. If another system controls the drive modes, safety controller 930 may communicate with the other system via communication interface 960 to direct that other system to not enter a drive mode. Other mechanisms for preventing movement of the vehicle when passenger seat 111 is not in driving mode may also be used by safety controller 930.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. An apparatus for repositioning a seat cushion for a vehicle passenger seat relative to a backrest of the vehicle passenger seat, the apparatus comprising:
the seat cushion;
a forward support affixed at a first end to an underside of the seat cushion;
a first pivot connecting a second end of the forward support to a vehicle floor, wherein the forward support and the seat cushion rotate around the first pivot between a driving position and a lounge position;
a rearward support that, when in a deployed position, supports a rearward end of the seat cushion from where the forward support is affixed in the lounge position, wherein the rearward support is in a stowed position when the seat cushion is in the driving position; and
a second pivot around which the rearward support rotates between the deployed position and the stowed position.

2. The apparatus of claim 1, comprising:
a latch located at an interface between the rearward end of the seat cushion and a bottom end of the backrest, wherein the latch is latched to a latch anchor when the seat cushion is in the driving position, wherein the latch prevents the seat cushion and the forward support from rotating around the first pivot when latched.

3. The apparatus of claim 2, wherein the latch is located on the rearward end of the seat cushion and the latch anchor is affixed to the vehicle floor.

4. The apparatus of claim 2, comprising:
a latch release that releases the latch from the latch anchor when pulled by a user.

5. The apparatus of claim 1, comprising:
a sensor indicating to a vehicle compute device whether the seat cushion is in the driving position or the lounge position.

6. The apparatus of claim 1, comprising:
a sensor indicating to a vehicle compute device whether the rearward support is in the deployed position or the stowed position.

7. The apparatus of claim 1, wherein the second pivot affixes the rearward support to the underside of the seat cushion and wherein the rearward support swings down from the seat cushion to reach the deployed position.

8. The apparatus of claim 1, wherein the second pivot affixes the rearward support to the vehicle floor and wherein the rearward support swings up from the vehicle floor to reach the deployed position.

9. The apparatus of claim 1, wherein a substantially inline surface is provided by the seat cushion and the backrest when the seat cushion is in the driving position and the backrest is fully reclined.

10. The apparatus of claim 1, wherein a catch affixed to the vehicle floor prevents the rearward support from moving into the stowed position until the seat cushion is rotated around the first pivot far enough for the rearward support to clear the catch.

11. A method for operating a vehicle having a passenger seat with a seat cushion moveable between a driving position and a lounge position, the method comprising:
receiving a signal from a sensor indicating whether the seat cushion is in the driving position; and
preventing the vehicle from entering a drive mode when the signal indicates the seat cushion is in the lounge position, wherein:
the seat cushion is in the lounge position when a rearward support is in a deployed position where the rearward support supports a reward end of the seat cushion from where a forward support supports the seat cushion, and
the rearward support is in a stowed position when the seat cushion is in the driving position.

12. The method of claim 11, comprising:
enabling the vehicle to enter the drive mode when the signal indicates the seat cushion is in the driving position.

13. The method of claim 12, wherein the signal indicates the seat cushion is in the lounge position to indicate the seat cushion is not in the driving position.

14. An apparatus to operate a vehicle having a passenger seat with a seat cushion moveable between a driving position and a lounge position, the apparatus comprising:
one or more computer readable storage media;
a processing system operatively coupled with the one or more computer readable storage media; and
program instructions stored on the one or more computer readable storage media that, when read and executed by the processing system, direct the apparatus to:
receive a signal from a sensor indicating whether the seat cushion is in the driving position; and
prevent the vehicle from entering a drive mode when the signal indicates the seat cushion is in the lounge position, wherein:
the seat cushion is in the lounge position when a rearward support is in a deployed position where the rearward support supports a reward end of the seat cushion from where a forward support supports the seat cushion, and
the rearward support is in a stowed position when the seat cushion is in the driving position.

15. The apparatus of claim 14, wherein the program instructions direct the processing system to:
enable the vehicle to enter the drive mode when the signal indicates the seat cushion is in the driving position.

16. The apparatus of claim 15, wherein the signal indicates the seat cushion is in the lounge position to indicate the seat cushion is not in the driving position.
